(19) United States
(12) Patent Application Publication
(10) Pub. No.: US 2018/0188374 A1
(43) Pub. Date: Jul. 5, 2018

(54) NAVIGATION SYSTERM AND METHOD FOR USING THE SAME

(71) Applicant: HON HAI PRECISION INDUSTRY CO., LTD., New Taipei (TW)

(72) Inventors: KUO-KUANG LIAO, New Taipei (TW); HUAN-WEN CHEN, New Taipei (TW)

(21) Appl. No.: 15/790,070

(22) Filed: Oct. 23, 2017

(30) Foreign Application Priority Data
Dec. 30, 2016 (TW) 105144258

(51) Int. Cl. G01S 17/93; G01S 19/51; H04W 4/04; G01C 21/36

(52) U.S. Cl. CPC G01S 17/936; G01C 21/3691; H04W 4/043; G01S 19/51

(57) ABSTRACT

A navigation system includes a navigation management module, a GPS navigation module, an LiDAR navigation module, an LiDAR navigation module and an environmental judgment module. The navigation management module is used to integrate and output navigation information and store map. The GPS navigation module is used to provide GPS navigation information to the navigation management module. The LiDAR navigation module is used to provide LiDAR information to the navigation management module. The environmental judgment module is used to determine whether the navigation system is indoors. The navigation management module is used to integrate and output different navigation information according to whether the navigation system is indoors.

### CROSS-REFERENCE TO RELATED APPLICATIONS

This application claims all benefits accruing under 35 U.S.C. §119 from Taiwan Patent Application No. 105144258, filed on Dec. 30, 2016, in the Taiwan Intellectual Property Office, the contents of which are hereby incorporated by reference.

### FIELD

The subject matter herein generally relates to a navigation system and a method for using the same.

### BACKGROUND

With the continuation of the map navigation technology, GPS positioning technology and base station positioning technology based on the navigation technology greatly enhance the convenience of daily travel. However, GPS navigation technology is only suitable for outdoor navigation, when the equipment into the room or tunnel, can not accept the GPS signal, the navigation system can not work, causing inconvenience.

What is needed, therefore, is to provide a navigation system and a method for using the same which can overcome the shortcomings as described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view showing base module of a navigation system provided according to embodiment of the present invention.

FIG. 2 is a chat flow showing a method for using a navigation system according to embodiment of the present invention.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The connection can be such that the objects are permanently connected or releasable connected. The term “substantially” is defined to be essentially conforming to the particular dimension, shape or other word that substantially modifies, such that the component need not be exact. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to a navigation system and a method for using the navigation system described in detail as below.

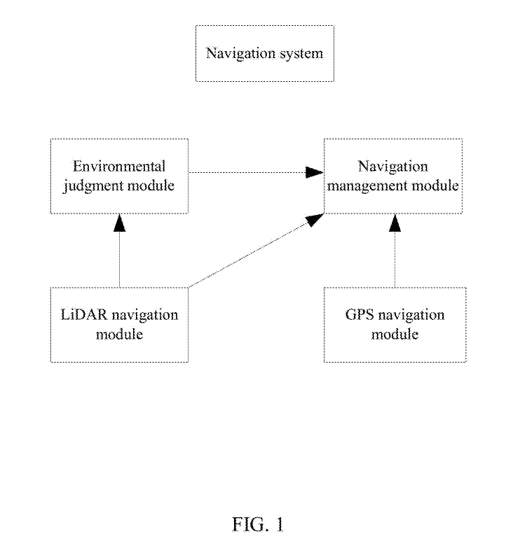

Referring to FIG. 1, a navigation system according to one embodiment is provided. The navigation system includes a navigation management module, a Global Positioning System (GPS) navigation module, an Light Detection and Ranging (LiDAR) navigation module, and an environmental judgment module. The navigation management module is used for integrating and outputting navigation information and storing map data. The GPS navigation module is used to provide GPS navigation information to the navigation management module. The LiDAR navigation module combines the LiDAR and Simultaneous Localization and Mapping (SLAM) algorithms to map maps and locate, and provides LiDAR navigation information and map data to the navigation management module. The environmental judgment module is used to determine whether the mobile device using the navigation system is indoors. The environmental judgment module can measure an elevation angle of the navigation system through LiDAR, collect the point cloud information, judge whether the navigation system is going to enter indoors, and provide these information to the navigation management module. If the navigation system is outdoors, the navigation management module processes the GPS navigation information and outputs the GPS navigation information to the mobile device. If the navigation system is indoors, the navigation management module processes the LiDAR navigation information and outputs the LiDAR navigation system to the mobile device

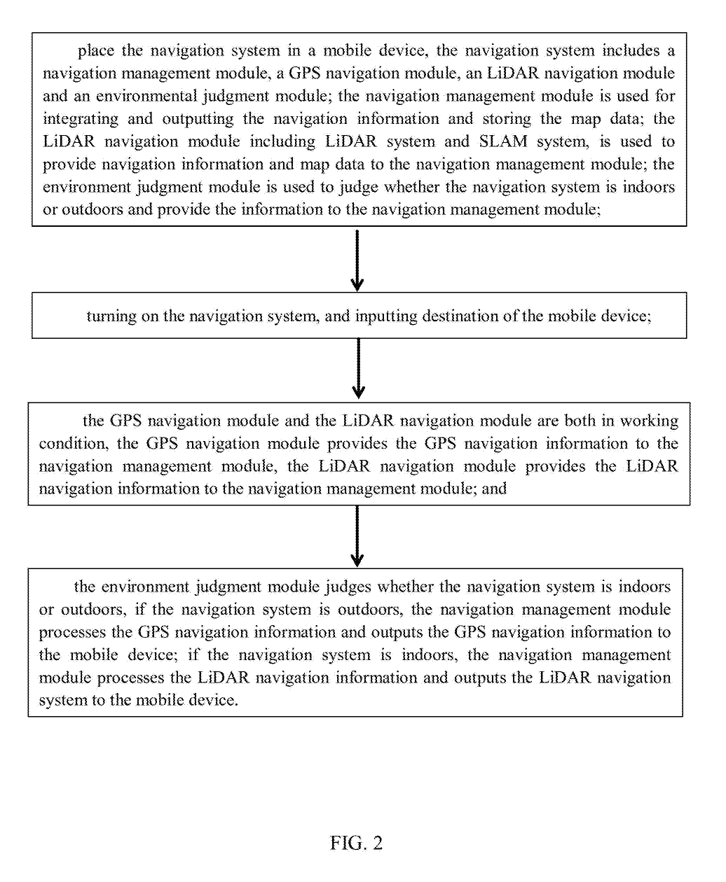

Referring to FIG. 2, a method for using the navigation system according to one embodiment is provided. The method for using the navigation system includes:

S1: place the navigation system in a mobile device, the navigation system includes a navigation management module, a GPS navigation module, an LiDAR navigation module and an environmental judgment module; the navigation management module is used for integrating and outputting the navigation information and storing the map data; the LiDAR navigation module including LiDAR system and SLAM system, is used to provide navigation information and map data to the navigation management module; the environment judgment module is used to judge whether the navigation system is indoors or outdoors and provide the information to the navigation management module;

S2: turning on the navigation system, and inputting destination of the mobile device;

S3: the GPS navigation module and the LiDAR navigation module are both in working condition, the GPS navigation module provides the GPS navigation information to the navigation management module, the LiDAR navigation module provides the LiDAR navigation information to the navigation management module; and

S4: the environment judgment module judges whether the navigation system is indoors or outdoors, if the navigation system is outdoors, the navigation management module processes the GPS navigation information and outputs the GPS navigation information to the mobile device; if the navigation system is indoors, the navigation management module processes the LiDAR navigation information and outputs the LiDAR navigation system to the mobile device.

In step S1, the mobile device may be an autonomous mobile device or a passive mobile device. The autonomous mobile device may be an unmanned vehicle, a robot, or the like. The passive mobile device may be a vehicle having a driver, a remote control robot, or the like. When the mobile device is an autonomous mobile device, the navigation system outputs navigation information to a central processor of the autonomous mobile device, and the central processor plans the autonomous mobile device to move in the route according to the navigation information. When the mobile device is a passive mobile device, the navigation system outputs the navigation information to a driver, and the driver controls the mobile device according to the navigation information.

In step S3, the LiDAR navigation module combined with LiDAR and SLAM algorithm to map the map to achieve positioning function. When the navigation management module stores the map information of the mobile device route, the LiDAR navigation module locates and navigates directly from the map information. When the navigation management module does not store the map information of the mobile device route, the LiDAR navigation module uses the SLAM algorithm to map an instant map of the mobile device route. The navigation system realizes the positioning and navigation of the mobile device according to the instant map. And the instant map information in transmitted to the navigation management module to store, next time the instant map can be directly used as a map stored in the navigation management module. The LiDAR navigation module can also draw an instant map using the SLAM algorithm. When it is found that the instant map is different from the stored map, the instant map can be used to replace the stored map. The stored map can be updated at any time.

In step S4, in one embodiment, the environmental determination module determines whether the mobile device is indoors through the LiDAR system. When the mobile device is going to enter indoors, the environmental judgment module detects an upper elevation angle of the navigation system through the LiDAR system to determine weather the navigation system indoors and then transmit the information to the navigation management module. In other embodiments, under a condition of the GPS signal is unusable or defective, even if the navigation system is outdoors, the environment determination module may also determine that the mobile device is indoor and passes the information to the navigation management module. When the navigation management module receives the information that the mobile device is indoors, the LiDAR navigation information provided by the LiDAR navigation module is processed, that is, the navigation system processes the LiDAR navigation information and the LiDAR navigation information is output to the mobile device. When the navigation management module dose not receive the information that the mobile device is indoors, the navigation system uses the GPS navigation module to provide GPS navigation information, that is, the navigation system processes the GPS navigation information and output the GPS navigation to the mobile device.

Compared with convention navigation system, the navigation system and the method for using the navigation system provided by the invention can switch using the GPS navigation module and the LiDAR navigation module according to the location of mobile device, and utilize the advantages of the two navigation modes to realize the indoor and outdoor Navigation function. The navigation system can be used in mobile devices such as automobiles, robots and so on.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A navigation system comprising:
a navigation management module configured to integrate and output navigation information and store map data;
a GPS navigation module configured to provide Global Positioning System (GPS) navigation information to the navigation management module;
a Light Detection and Ranging (LiDAR) navigation module configured to provide LiDAR information to the navigation management module;
an environmental judgment module configured to determine whether the navigation system is indoors; and
wherein the navigation management module is configured to integrate and output different navigation information according to whether the navigation system is indoors.

2. The system of claim 1, wherein the LiDAR navigation module comprises an LiDAR system and a Simultaneous Localization and Mapping (SLAM) system.

3. The system of claim 1, wherein the LiDAR navigation module combines the LiDAR and SLAM algorithms to map maps and locate.

4. The system of claim 3, wherein the LiDAR navigation module provides LiDAR navigation information and map data to the navigation management module.

5. A method for using a navigation system comprising:
S1: place the navigation system in a mobile device, the navigation system comprising a navigation management module, a Global Positioning System (GPS) navigation module, a Light Detection and Ranging (LiDAR) navigation module and an environmental judgment module; the navigation management module being configured to integrate and output the navigation information and store the map data; the LiDAR navigation module comprising an LiDAR system and an Simultaneous Localization and Mapping (SLAM) system, being configured to provide navigation information and a map to the navigation management module; the environment judgment module being configured to judge whether the navigation system is indoors or outdoors and provide the information to the navigation management module;
S2: turning on the navigation system, and inputting destination of the mobile device;
S3: the GPS navigation module and the LiDAR navigation module being in working condition, the GPS navigation module providing the GPS navigation information to the navigation management module, the LiDAR navigation module providing the LiDAR navigation information to the navigation management module; and
S4: the environment judgment module judging whether the navigation system is indoors or outdoors, if the navigation system being outdoors, the navigation management module processes the GPS navigation information and outputting the GPS navigation information to the mobile device; if the navigation system being indoors, the navigation management module processes the LiDAR navigation information and outputting the LiDAR navigation system to the mobile device.

6. The method of claim 5, wherein the mobile device is an autonomous mobile device or a passive mobile device.

7. The method of claim 5, wherein the mobile device is an autonomous mobile device, the navigation system outputs navigation information to a central processor of the autonomous mobile device, and the central processor plans the autonomous mobile device to move in the route according to the navigation information.

8. The method of claim 5, wherein the mobile device is a passive mobile device, the navigation system outputs the navigation information to a driver, and the driver controls the mobile device according to the navigation information.

9. The method of claim 5, wherein the LiDAR navigation module combines with LiDAR and SLAM algorithm to map the map to achieve positioning function.

10. The method of claim 5, wherein the navigation management module stores the map information of the mobile device route, the LiDAR navigation module locates and navigates directly from the map information.

11. The method of claim 5, wherein the LiDAR navigation module uses the SLAM algorithm to map an instant map of the mobile device route. The navigation system realizes the positioning and navigation of the mobile device according to the instant map.

12. The method of claim 5, wherein if the mobile device is going to enter indoors, the environmental judgment module detects an upper elevation angle of the navigation system through the LiDAR system to determine weather the navigation system indoors and then transmit the information to the navigation management module.

13. The method of claim 1, wherein under a condition of the GPS signal is unusable or defective, the navigation system is outdoors, the environment determination module determines that the mobile device is indoor and passes the information to the navigation management module.
